(19) United States
(12) Patent Application Publication
(10) Pub. No.: US 2026/0203364 A1
(43) Pub. Date: Jul. 16, 2026

(54) CONTEXTUAL ENVELOPING OF DYNAMIC HYPERLINKS

(71) Applicant: BUBBLR LIMITED, London (GB)

(72) Inventor: Stephen MORRIS, Fife (GB)

(73) Assignee: BUBBLR LIMITED, London (GB)

(21) Appl. No.: 19/127,095

(22) PCT Filed: Nov. 2, 2023
(86) PCT No.: PCT/EP2023/080609

§ 371 Date: May 2, 2025

Related U.S. Application Data
(63) Continuation of application No. 17/980,298, filed on Nov. 3, 2022, now abandoned.

(51) Int. Cl. G06F 16/955; G06F 3/04817; G06F 16/9532; G06F 16/9535

(52) U.S. Cl. CPC G06F 16/9558; G06F 3/04817; G06F 16/9532; G06F 16/9535

(57) ABSTRACT

A contextual linkage search tool system and method wherein a graphic icon indicating a possible next stage of a search query sequence is returned in response to an initial user input search query. The possible next stage of the search query sequence is determined by reviewing search history data to determine locational and temporally relevant search results to the user and their initial query.

### FIELD OF THE INVENTION

The present invention relates to a contextual linkage search tool system and method therefore. More particularly, but not exclusively, it relates to a system for, and method of, providing a navigable search tool based upon the contextual link between a search query and a dynamic hyperlink associated with a possible search result.

### BACKGROUND TO THE INVENTION

Search engines use multi-factor based search algorithms to attempt to optimise search results for users from indexed web pages. Possibly the best known of search engine is Google which uses in excess of fifty signals to attempt to personalise web search results for a user. For example a user's prior search history, their prior web browsing history and their location can be used to attempt to provide tailored recommendations from a web search.

However, these attempts to introduce context are limited in their usefulness and results in the generation of search results that, whilst they may be precise, also contain many irrelevant results within which the user must search through manually in order to obtain the information that is actually relevant to their enquiry. For example, with a traditional search engine, if the search query produces unsatisfactory results, you just have to start again and try a different search query.

Furthermore, the lack of context precludes search engines from provide accurate sequential search suggestions where the user enters a first search query, the results of which guide the user to a second search query in order to provide a flow of sequential searches to arrive at the user's desired highly detailed and context laden search result. Such searches are particularly useful where the user may be visually or physically impaired and reliant upon a simplified user interface, typically, but not exclusively, graphical, to enter and progress their search queries. This lack of context makes the suggestion of further steps in the search process impossible. For example, when searching for “Liverpool Champions League” the first search result is the club's history in the competition, not details of the next upcoming fixture.

There is no context applied to the search as to what is relevant to users at the time of the search other than standard signals such as location, a personal search history etc., and this limits the accuracy of the search performed by existing search engines. Additionally, established content consumption models merely registers ‘clicks’ which is a crude, inaccurate approximation of content and has also resulted in the undesirable proliferation of clickbait.

Furthermore, outputs from existing search engines are predominantly textual which limits their usability by visually and physically impaired users as multiple interactions must be made to enact a search. This is particularly the case where a mobile device is used and the on screen keyboard is small, which presents issues for those with visual and physical impairments. Also, more generally, all internet search engines operate by allowing a user to enter a written query into a text box. Even app-based search engines just provision a text box in the app for the user to enter their written search query. However, text boxes and utilising the keyboard are largely antithetical to mobile app users who would prefer to use finger tap controls to interact with their apps.

### SUMMARY OF THE INVENTION

According to a first aspect of the present invention there is a computer implemented method of contextual searching of indexed data comprising the steps of:
searching indexed data for result data records relevant to one or more keywords defined in a search request,
processing history data records in a database of search requests to establish a context associated with the search request;
scoring the result data records according to their relevance to the established context; and
dynamically hyperlinking to one or more result data records having a relevance score above a predetermined threshold in relation to the established context.

This provides a search result that that is contextually relevant to the search request by ranking search results according to a context established with reference to earlier searches. This search mechanism encourages the user to build an iterative and optimised to derive more complex search query which engages the user in a fashion appropriate for dynamic research. Encouraging the user to easily refine their search to give them the answers they are looking for.

Processing the history data records may comprise collating history data records within a pre-defined time period of a particular time. Processing the history data records may comprise extracting common search terms with the history data records, preferably within the pre-defined time period of the particular time. The history data records may comprise data corresponding to search results of at least one prior search. The indexed data may comprise indexed webpage data.

This provides for time constrained context data to be extracted from a single user's search results or a number of user's search results which allows the search to determine what other people are currently searching for using a primary search term. It will be appreciated that, when considering searches by third party users albeit this data is be captured anonymously if required by local data privacy regulations.

The one or more keywords may comprise one or more named entities in natural language processing.

Processing the history records may comprise querying metadata associated with the records. Querying the metadata may comprise cross-referencing time data with search query content.

The history database may comprise a graph database. History data records may comprise nodes of the graph database. Scoring the result data base may comprise analysing edge weights between nodes of the graph database. Processing the history data records may comprise varying the weights of the edges of the graph database. Varying the weights of the edges of the graph database may comprise analysing metadata in labels of the graph database which are associated with the edges of the graph database. Analysing the metadata in labels associated with the edges of the graph database may comprise analysing at least one of the following: time of search result, amount of search result reviewed, prior relevance score.

The use of a graph database provides existing linkages between search results and further allows the relevance of those linkages to be varied, for example, by way of non-limiting example, decreasing with time such that up to date relevance scoring is effective. It also has the effect of being a forecast auto completion mechanism that matches previously requested popular searches. This results in well defined, structured queries.

The method may comprise creating at least one dynamic link by calling data corresponding to the graph node having a relevance score above the predetermined threshold. The method may comprise inserting the at least one dynamic link in to a document to be viewed by a user. The method may comprise inserting the dynamic link in to an application being used by a user.

The ability to provide a dynamic link into a document viewed by a user allows the user to have direct access to the contextual search results as they are reviewing existing work.

The method may comprise inserting the at least one dynamic link into an application as a graphic icon. Clicking on the graphic icon may cause a further search step iteration. The further search iteration may be a contextual based search. The further search iteration may comprise a forecast auto completion operation. The application may comprise a search engine.

The use of a graphic icon as a search step initiator following contextual analysis provides the ability to progress a sequential search with only a single initial textual input which provides enhanced usability for visually or physically impaired user to progress through search steps to arrive at their desired information. As such questions can be readily provisioned by a cascade of mobile ‘tap’ controls to help define the search and only utilising a text entry when it is essential, for example for the first search term.

According to a second aspect of the present invention there is a software application which when executed on a processor causes the processor to operate in accordance with the first aspect of the present invention.

According to third aspect of the present invention there is provided a system comprising a user device and a processor, wherein the user device is arranged to display a search application and is further arranged to receive a user generated search request and to pass the search request to the processor such that the processor can execute the application according to the second aspect of the present disclosure and return a dynamic link to the search application, wherein the dynamic link corresponds to a context based search result.

According to a fourth aspect of the present invention there is provided a processor arranged to execute the application according to the second aspect of the present invention.

According to a fifth aspect of the present invention there is provided a processor arranged to execute the method according to the first aspect of the present invention.

### BRIEF DESCRITPION OF THE DRAWINGS

The present invention will now be described, by way of non-limiting example only, with reference to the accompanying drawings, in which:

FIG. 1 is a schematic representation of a computing system adapted to execute a method a computer implemented method of contextual searching of indexed data according to at an aspect of the present invention and a user device comprising a processor and an application in accordance with respective other aspects of the present invention;

FIG. 2 is a schematic representation of a user device comprising a processor and an application in accordance with respective other aspects of the present invention; and

FIG. 3 is a flow chart detailing a computer implemented method of contextual searching of indexed data according to an aspect of the present invention.

### DETAILED DESCRIPTION OF EMBODIMENTS OF THE INVENTION

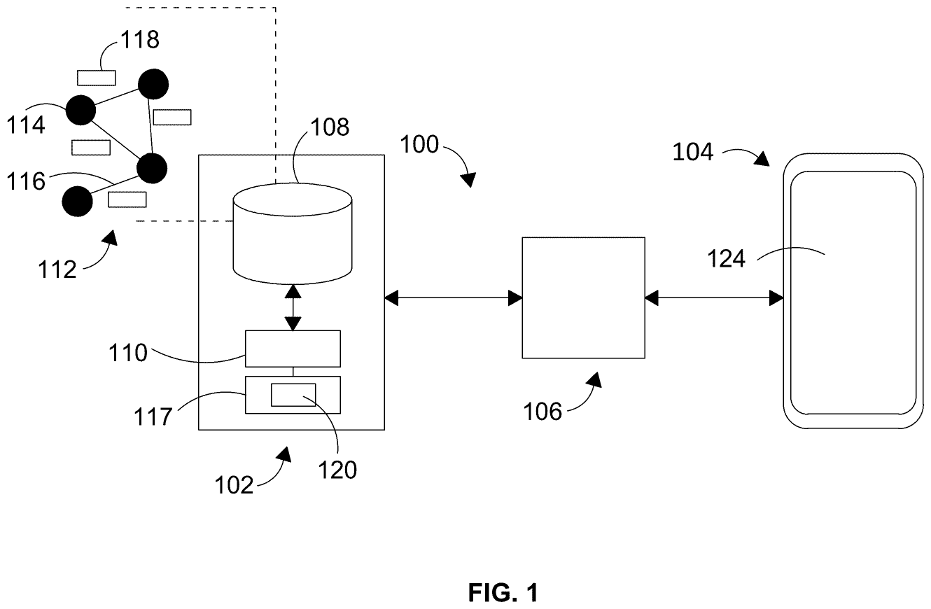

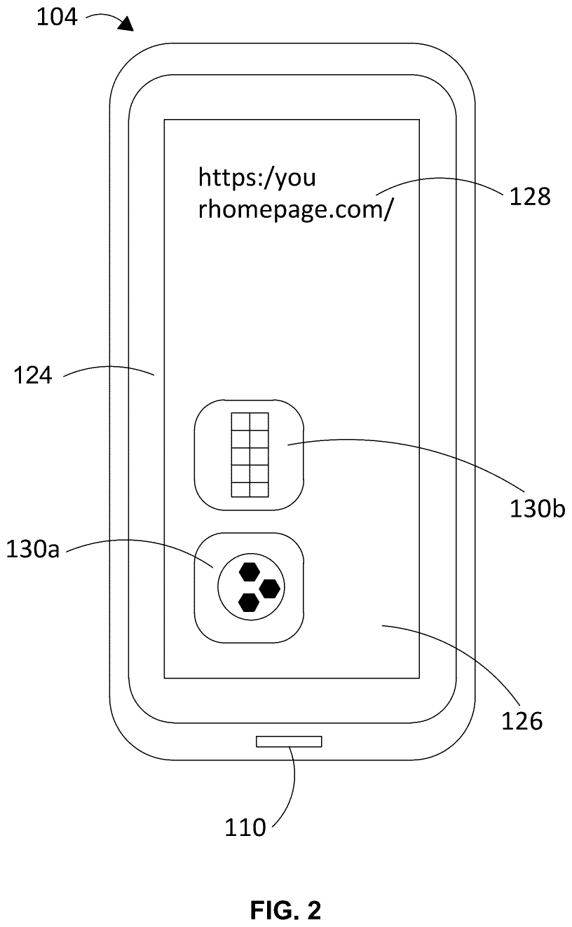

Referring now to FIGS. 1 and 2, a computing system 100 comprises a semantic database system 102, a user device 104 and a network 106.

The semantic database system 102 comprises a storage device 108 and a processor 110. The storage device 108 stores a copy of a semantic database, typically but not exclusively, a knowledge graph 112 and the processor 110 is arranged to perform operations upon the knowledge graph 112. It will be appreciated that there may be a plurality of storage devices, each storing either a full or partial copy of the knowledge graph and there may be a plurality of processors.

The knowledge graph 112 comprises nodes 114, edges 116, labels 118 associated with the edges 116 and a graph query tool 117. The nodes 114 represent, for example previous searches and the search results associated therewith. These historic search records may be related to searches carried out by the user or they could more broadly include searches and search results carried out by the user and/or third parties. The edges 116 represent the relationships between the nodes 114, i.e. is there a link between searches, for example do they relate to the same or similar subject matter. The labels 118 detail the semantics, nature of the relationships, associated with the edges 116. For example, the labels 118 comprise metadata describing relationships in terms of, by way of non-limiting example, classification, ontology, historical information, the time that the search was carried out, the search terms, a degree of content consumption of documents listed in the search results and the like.

The graph nodes 114 comprise a graph data store 120, typically as a submodule of the graph nodes 114. The graph data store 120 persists maintains the knowledge graph 112 by processing graph configuration updates received at the graph nodes 114 such that an updated graph data structure is output to the graph nodes 114 which migrate the updated configuration to their local data graph. These configuration updates typically relate to the addition or deletion of graph nodes 114 and/or edges 116, or the updating of weighting associated with edges 116.

The graph query tool 117 comprises a semantic search query generation logic (SSQGL) engine 122 configured to convert the input data provided by the user into a semantic search query comprising a plurality of search criteria for retrieving for example data, metadata or operative statements the KG 112. Typically, the graph query tool 117 comprises libraries and respective graph query languages, such as, by way on non-limiting example, SPARQL, GQL, Cypher, Gremlin, GraphQL, associated with different types of graph data models. The graph query tool 117 is arranged to perform analytics and information retrieval and derivation queries submitted by a user via user queries input via the user device 104. The user queries typically, but not exclusively, being in the form of plain text queries, usually but not exclusively natural language queries. In an alternative or additional embodiment the query may comprise an input via a graphical user interface or a combination of natural queries and graphical user interface input.

The user device 104 comprises a touch screen 122 and a processor 124 running an application 126. The application 126 is typically a standard search engine user interface or a bespoke contextual search application. The user device 104 is typically, by way of non-limiting example a mobile device such as a mobile telephone, a smart watch, a tablet or a personal computer.

The network 106 places the semantic database system 102 and the user device 104 in communication with each other. Typically, the network 106 is the Internet, although it will be appreciated that a local or private network can be used if appropriate.

In use, a user enters a first stage search query via the application 126 running on the user device 104. It will be appreciated that the first stage search query may be, by way on non-limiting example, a text based natural language search query entered at a query box of the application 126, or it may be a speech based natural language search query entered via a microphone of the user device 104 and processed by the application 126. In another embodiment the search query may comprise a captured or downloaded image which is processed by the application 126 to extract relevant natural language content or to recognise a possible search term via image recognition, for example to use the search term “dog” if a dog is pictured in the image. Thus, a user could use a result from an image search as a proxy graphic icon to instigate a search using the tool of the present invention.

Data corresponding to the search query is passed from the user device 104 to the sematic database system 102 via the network 106.

In one embodiment, the processor 110 processes the search query by parsing the search query and passing the parsed query to the graph query tool 117, an example of how to create a SPARQL query for querying a knowledge graph from a natural language query can be found at:

https://www.researchgate.net/publication/
345100222_Querying_Knowledge_Graphs_in_Nat
ural_Language/link/5f9fe1a6a6fdccfd7b94add4/
download.

The graph query tool 117 interrogates the knowledge graph 112 to establish the most relevant prior search result. The graph query tool 117 establishes the most relevant prior search result by querying labels 118 associated with edges 116 indicating where a relationship between prior searches exists to determine if the search terms used in generating the search results stores at the nodes 114 correspond or are related to the user input search query. For example, if the USA are playing Canada at ice hockey today, and someone in Canada begins a query with “What time . . . ”, the algorithm will review the user's location to establish that they are in the USA and that the most relevant search queries to the user query within a specified time window, for example the last 12 hours, relate to the start time of the USA v Canada ice hockey match. The algorithm with therefore be able to predict that the full user query has a high probability of being “What time does the ice hockey game between USA and Canada start”, and the user may be prompted by an icon of a hockey stick to complete their search query.

Furthermore, the edges 116 of the knowledge graph will have weights associated with them indicating the relative contextual importance of each edge 116 between nodes 114. As a non-limiting example, an edge 116 between nodes 114 with search results generated in the last half an hour may have a higher weighting than an edge 116 between nodes 114 corresponding to search results generated two days ago as the more recently generated search results are more contextually relevant to a current search query than those generated some time ago. As a further non-limiting example, additionally or alternatively, edges 116 may be weighted by the number of times a particular search has been run, for example a search for “Liverpool” may be run one thousand times per hour and “Liverpool Football Club” run 750 times per hour, consequently an edge 116 leading to a node 114 corresponding to a search result for “Liverpool Football Club” may be weighted slightly less than to a node 114 corresponding to a search result for “Liverpool”. In a preferred embodiment, an algorithm calculating the contextual relevance uses the Timeliness, i.e. the time relative to the current search and location are included as part of the algorithm along with the edge weightings. Thus the keywords can comprise, by way of non-limiting example, especially named entities in natural language processing terms.

A yet further non-limiting example of an edge weighting criteria is the amount of content consumed by a user once they activated a search result stored as a node 114. Typically, only clicks through to other web pages are measured to determine user content consumption. However, in the case of a bespoke search application it is possible to monitor a number of content consumption parameters in addition to click throughs, for example by way of non-limiting independent examples: the rate of scrolling through a webpage, the frequency of scrolling, the copying of content to a clipboard, if copying of content takes place where in the document, what type of content is copied (image, or text), screen saver becoming activated. Thus, an edge 116 to a search result to content with low content consumption may be weighted lower than an edge to a search result with high content consumption.

Typically, details of the factors contributing to edge weightings will be stored in the edge's respective labels 118.

It will be appreciated that any single, or combination, of the aforementioned weighting factors may be used to weight an edge 116 between nodes 114. Furthermore, the graph data store 120 runs update procedures that will update the edge weightings according to rules in a rule database as part of graph configuration updates.

The edge weightings are applied when running the graph query tool 117 to establish a ranking of search results enveloped by their contextual relevance. Data corresponding to the most relevant search result is passed back across the network 106, to the user device 104 and to the application 126. Typically, but not exclusively, the ranking of search results by their contextual relevance is executed using Term Frequency-Inverse Document Frequency (TF-IDF).

TF-IDF multiplies two metrics, term frequency (TF), how many times a word appears in a document and inverse document frequency (IDF): the inverse document frequency of the word across a collection of documents to arrive a contextual relevance score. Rare words have high scores, common words have low scores.
For example the query may be Q: Liverpool Match.
D1: The next Liverpool home match Saturday.
D2: The Liverpool away match is at Everton.
D3: The Everton match postponed.

TF (word, document)=“number of occurrences of the word in the document”/“number of words in the document”

Let's compute the TF scores of the words “the” and “cat” (i.e. the query words) with respect to the documents D1, D2, and D3.

$$\begin{matrix}TF ( “ the ” , D 1 ) = 2 / 6 = 0.33 \\ TF ( “ the ” , D 2 ) = 1 / 7 = 0.14 \\ TF ( “ the ” , D 3 ) = 1 / 4 = 0.25 \\ TF ( “ Liverpool ” , D 1 ) = 1 / 6 = 0.17 \\ TF ( “ Liverpool ” , D 2 ) = 1 / 7 = 0.14 \\ TF ( “ Liverpool ” , D 3 ) = 0 / 4 = 0\end{matrix}$$

IDF can be calculated by taking the total number of documents, dividing it by the number of documents that contain a word, and calculating the logarithm of that value. Common words will have an IDF close to zero, infrequently occurring words an IDF close to 1.

$$IDF ( word ) = log ( number of documents / number of documents that contain the word )$$

Let's compute the IDF scores of the words “the” and “Liverpool”.

$$\begin{matrix}IDF ( “ the ” ) = log ( 3 / 3 ) = log ( 1 ) = 0 \\ IDF ( “ Liverpool ” ) = log ( 3 / 2 ) = 0.18\end{matrix}$$

Multiplying TF and IDF gives the TF-IDF score of a word in a document. The higher the score, the more contextually relevant that word within any given document.

$$\begin{matrix}TF - IDF ( “ the ” , D 1 ) = 0.33 * 0 = 0 \\ TF - IDF ( “ the ” , D 2 ) = 0.14 * 0 = 0 \\ TF - IDF ( “ the ” , D 3 ) = 0.25 * 0 = 0 \\ TF - IDF ( “ Liverpool ” , D 1 ) = 0.17 * 0.18 = 0.0306 \\ TF - IDF ( “ Liverpool ” , D 2 ) = 0.14 * 0.18 = 0.0252 \\ TF - IDF ( “ Liverpool ” , D 3 ) = 0 * 0 = 0\end{matrix}$$

The documents are then ranked using a ranking function to order the documents according to the TF-IDF scores of their words. Any suitable ranking function can be used

The application 126 uses a script to create a dynamic link 128 that links to the search result in the knowledge graph 112 corresponding to highest contextual relevance. The script takes the search result data from the knowledge graph 112 database to create a custom dynamic link from a template, inserting the contextually most relevant search results to the user query.

In some embodiments, the dynamic link 128 may be textual of the exemplary, non-limiting, form:
http://www.yourhomepage.com/lvierpool.php?hotelid=12345&availability=280522

Such a textual dynamic link 128 may be displayed as a search result in a manner which will be appreciated by the person skilled in the art. Alternatively, where the application 126 is a bespoke search application the dynamic link 128 may be embedded in content that the user is already viewing to provide a consequential, sequential search experience.

In an alternative, or additional, example the dynamic link 128 may be displayed within the application 126 as a search result button 130a,b such that the user can progress sequentially through the search process to arrive at the final user desired search result and its associated content. This is particularly relevant for mobile device users who are used to icon based interactions and also for visually and physically impaired users who

It will be appreciated that in order to facilitate user search options more than one dynamic link may be generated and output at the user device 104, typically but not essentially via the application 126. For example, this allows the two most contextually relevant search results to be displayed as this provides the user with options to choose from to progress their search to reach their desired end search result.

For example, a search query run for the search term “Liverpool” results in the two highest contextual rankings for “Football” and “Accommodation”. As such the application the application 1126 causes icons 130a, b representing sport and a hotel to be displayed on the touch screen. In this current, non-limiting, example, the terms “Football” and “Accommodation” may be the most highly sought after search terms related to Liverpool in the last twenty four hours, this search prevalence measure is not limited to the user's own search but encompasses all search queries for “Liverpool” carried out by using an instantiation of the application 126 across all user devices 104.

The should the user select the hotel icon 130b be actuated via the touch screen 122 of the user device 104 a search query is forwarded to the semantic database system 102 to search for accommodation in Liverpool. In at least one embodiment, the graph query tool 117 identifies recent popular searches with this ontology and extracts the dates within these recent searches to which these recent searches relate and completes a forecast auto completion operation to matches the search for recently requested popular searches. The sematic database system returns an option for accommodation in Liverpool on the dates defined in the recent popular searches for output to the user via the user device 104. Thus the user experiences a well-defined, structured query with minimal textual input. Indeed, in some instances an icon can be used to instigate the structured search query so that no text based input is required, this can be based upon analysis of the user's recent search history, and/or that of other users operating the application 126.

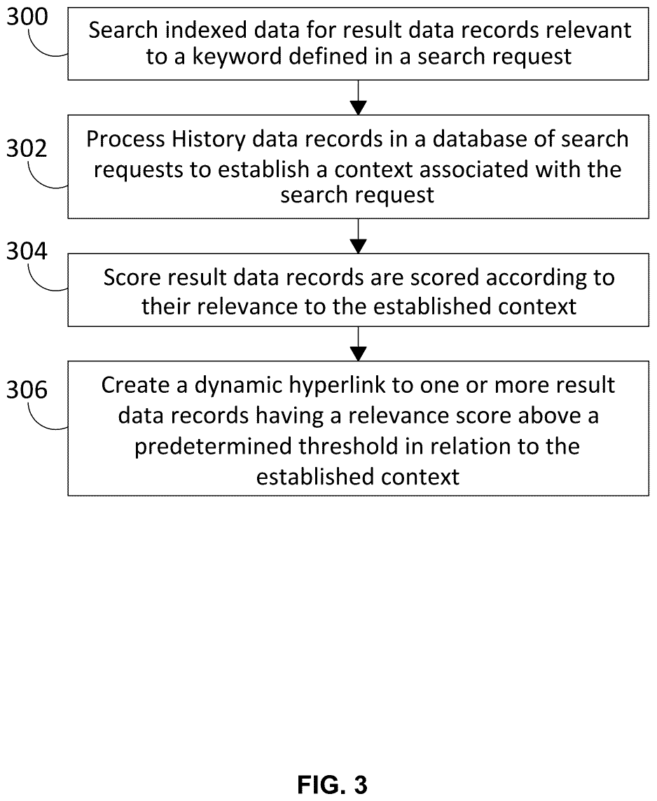

Referring now to FIG. 3, a computer implemented method of contextual searching of indexed data comprises searching indexed data for result data records relevant to a keyword defined in a search request (Step 300). History data records in a database of search requests are processed to establish a context associated with the search request (Step 302). The result data records are scored according to their relevance to the established context (Step 304). A dynamic hyperlink is created to one or more result data records having a relevance score above a predetermined threshold in relation to the established context (Step 306).

It will be appreciated by the person skilled in the art that although described with reference to a knowledge graph any other suitable form of semantic database can be used.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. The computer readable program instructions for carrying out operations of the embodiments of the invention may be, for example, assembly language or either source code or object code is written in any combination of one or more programming languages.

The program code embodied in any of the applications/modules described herein is capable of being individually or collectively distributed as a program product in a variety of different forms. In particular, the program code may be distributed using the computer readable storage medium having the computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other robust state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general-purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more, or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

1. A computer implemented method of contextual searching of indexed data comprising the steps of:
searching indexed data for result data records relevant to one or more keywords defined in a search request;
processing history data records in a database of search requests to establish a context associated with the search request;
scoring the result data records according to their relevance to the established context; and
dynamically hyperlinking to one or more result data records having a relevance score above a predetermined threshold in relation to the established context.

2. The method of claim 1 wherein, the one or more keywords comprise named entities in natural language processing.

3. The method of claim 1 wherein, processing the history data records comprises collating history data records within a pre-defined time period of a particular time.

4. The method of claim 2 wherein, processing the history data records comprises extracting common search terms with the history data records, within the pre-defined time period of the particular time.

5. The method of claim 1 wherein, the history data records comprises search results of more than one user.

6. The method of claim 1 wherein, processing the history records comprises querying metadata associated with the records.

7. The method of claim 6 wherein, querying the metadata comprises cross-referencing time data with search query content.

8. The method of claim 1 wherein, the history database comprises a graph database and the history data records comprise nodes of the graph database.

9. The method of claim 8 wherein, scoring the result database comprises analysing edge weights between nodes of the graph database.

10. The method of claim 8 wherein, processing the history data records comprises varying weights of edges of the graph database.

11. The method of claim 10 wherein, varying the weights of the edges of the graph database comprises analysing metadata in labels of the graph database that are associated with the edges of the graph database.

12. The method of claim 11 wherein, analysing the metadata in labels associated with the edges of the graph database comprises analysing at least one of the following: time of search result, amount of search result reviewed, prior relevance score.

13. The method of claim 8 wherein, dynamically hyperlinking comprises creating at least one dynamic link by calling data corresponding to the graph node having a relevance score above the predetermined threshold.

14. The method of claim 13, comprising inserting the at least one dynamic link in to a document to be viewed by a user.

15. The method of claim 13, comprising inserting the at least one dynamic link into an application as a graphic icon and wherein clicking on the graphic icon may cause a further search step iteration.

16. The method of claim 15 wherein, the further search iteration comprises a forecast auto completion operation.

17. The method of claim 15 wherein, the application comprises a search engine.

18. The method of claim 1 wherein, the indexed data comprises indexed webpage data.

19. A software application which when executed on a processor causes the processor to execute the method of any preceding claim.

20. A system comprising a user device and a processor, wherein the user device is arranged to display a search application and is further arranged to receive a user generated search request and to pass the search request to the processor such that the processor can execute the application according to claim 19 and return a dynamic link to the search application, wherein the dynamic link corresponds to a context based search result.

21. A processor arranged to execute the method of claim 1.
